(19) United States
(12) Patent Application Publication
(10) Pub. No.: US 2019/0220923 A1
(43) Pub. Date: Jul. 18, 2019

(54) SOFTWARE-IMPLEMENTED APPRAISAL METHOD

(71) Applicant: BDG Holdings, LLC, Washington, DC (US)

(72) Inventor: Alon Street, Washington, DC (US)

(73) Assignee: BDG Holdings, LLC, Washington, DC (US)

(21) Appl. No.: 16/248,727

(22) Filed: Jan. 15, 2019

Related U.S. Application Data
(60) Provisional application No. 62/617,439, filed on Jan. 15, 2018.

(51) Int. Cl. G06Q 40/02; G06Q 50/16

(52) U.S. Cl. CPC G06Q 40/025; G06Q 50/163

(57) ABSTRACT

A software-implemented appraisal method that includes receiving a digital appraisal request at a server, wherein the digital appraisal request represents a home appraisal site inspection job and includes a home physical address. The method includes communicating the home appraisal site inspection job to a plurality of appraiser users communicatively coupled to the server over a closed wireless network, receiving, at the server, an acceptance of the home appraisal site inspection job by one of the plurality of appraiser users, and, after acceptance of the home appraisal site inspection job by one of the plurality of appraiser users, communicating the home physical address to the one of the plurality of users for completion of the home site inspection job appraisal job. The method also includes receiving, at the server, a plurality of home site data from the one of the plurality of appraiser users to generate an appraisal value.

### CROSS-REFERENCE TO RELATED APPLICATION

This application claims priority to U.S. Provisional Patent Application No. 62/617,439 filed Jan. 15, 2018, the entirety of which is incorporated by reference.

### FIELD OF THE INVENTION

The present invention relates generally to computer-implemented appraisal methods, and, more particularly, relates to a computer-implemented appraisal method that effectively and efficiently manages and coordinates home appraisals.

### BACKGROUND OF THE INVENTION

Many banking institutions and other lenders are desirous to obtain an appraisal of a home, building, or other property. While generally applied to residential or commercial properties, the appraisal process is beneficial in a variety of different settings. Appraisals are generally understood as an unbiased estimate of the true (or fair market) value of what a home or property is worth. All lenders generally order an appraisal during the mortgage loan process so that there is an objective way to assess the home's market value and ensure that the amount of money requested by the borrower is appropriate. The appraisal can include recent sales information for similar properties, the current condition of the property, and the location of the property, i.e., insight as to how the neighborhood impacts the property's value. This appraisal process, however, is often a time-consuming, arduous, and mistake-prone endeavor.

Typically, appraisals are conducted by highly-trained professionals who are licensed and/or certified to determine the value of a home fairly, objectively and without bias in the state where the property is located. While no appraiser is infallible, his or her opinion of the value of your home is often informed by training, numerous tests, years of on-the-job experience and required continuing education. They are also required to substantiate every finding in their reports that could influence a home's value. However, in many instances, there is no way to confirm the information is accurate or effectively and efficiently get that information to the lender. Additionally, consequences of issuing deliberately misleading or biased reports can be severe, so appraisers work hard to remain impartial and keep personal value judgments and prejudices out of their work.

When appraising a business, home, or other property (generally referred to herein as a “home appraisal site inspection job”), appraisers are generally looking at the condition of what is permanently part of or attached to the house. They are generally not evaluating the décor or furniture or anything that's not affixed to the property; this is principally because the generally most important data associated with a home appraisal site inspection job is the property's physical characteristics (age, square footage, the number of bedrooms and baths, lot size, location, view) as well as their observable condition.

Therefore, a need exists to overcome the problems with the prior art as discussed above.

### SUMMARY OF THE INVENTION

The invention provides a software-implemented appraisal method that overcomes the hereinafore-mentioned disadvantages of the heretofore-known devices and methods of this general type and that effectively, quickly, and efficiently relays information relating to a home appraisal site inspection job to a lender for evaluation.

With the foregoing and other objects in view, there is provided, in accordance with the invention, a software-implemented appraisal method is disclosed that includes the steps of receiving a digital appraisal request at a server, wherein the digital appraisal request representing a home appraisal site inspection job and including a home physical address. The method also includes communicating, from the server, the home appraisal site inspection job to a plurality of appraiser users communicatively coupled to the server over a closed wireless network and receiving, at the server, an acceptance of the home appraisal site inspection job by one of the plurality of appraiser users. Additionally, after acceptance of the home appraisal site inspection job by one of the plurality of appraiser users, the method includes communicating the home physical address to the one of the plurality of users for completion of the home site inspection job appraisal job. The method also includes receiving, at the server, a plurality of home site data from the one of the plurality of appraiser users.

In accordance with another feature, an embodiment of the present invention includes computing, after receiving the plurality of home site data, an appraisal value utilizing the plurality of home site data.

In accordance with yet another feature, an embodiment of the present invention also includes initiating, after communicating the home appraisal site inspection job to the plurality of appraiser users, a timer on the server, wherein the home physical address of the home site inspection job appraisal job is communicated to the one of the plurality of appraiser users corresponding to a first received acceptance of the home appraisal site inspection job based on the timer.

In accordance with an additional feature, an embodiment of the present invention includes communicatively and dynamically integrating an MLS electronic database with the server, autonomously receiving a plurality of home appraisal site inspection job data from the MLS electronic database, and computing, after receiving the plurality of home site data from the one of the plurality of appraiser users and from the plurality of home appraisal site inspection job data from the MLS electronic database, the appraisal value from the home site data and the home appraisal site inspection job data.

In accordance with another feature, an embodiment of the present invention includes communicating the home physical address to the one of the plurality of users for completion of the home site inspection job appraisal job by a banking institution.

In accordance with yet another feature, an embodiment of the present invention also includes receiving, at the server, an acceptance of the home appraisal site inspection job through a user input provided on an electronic computing device of the one of the plurality of appraiser users, the electronic computer device communicatively coupled to the closed wireless network.

Although the invention is illustrated and described herein as embodied in a software-implemented appraisal method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of a software-implemented appraisal method implemented over a closed-network in accordance with one exemplary embodiment of the present invention;

FIG. 2 a block diagram of an exemplary computing device utilized in the software-implemented appraisal method depicted in FIG. 1;

FIGS. 3-8 are exemplary screen shots depicting user interfaces associated with the software-implemented appraisal method depicted in FIG. 1; and

FIG. 9 is a process flow diagram depicting steps associated with the software-implemented appraisal method in FIG. 1 in accordance with one exemplary embodiment of the present invention.

### DETAILED DESCRIPTION OF INVENTION

The invention described herein provides a software-implemented appraisal method and system that provides a software application configured to solicit and retain one of a plurality of appraiser users for an appraiser job that the application facilitates in executing and recording and/or documenting. The present invention overcomes known disadvantages of those known devices and methods of this general type and that includes firmware and software to effectuate an efficient appraisal process.

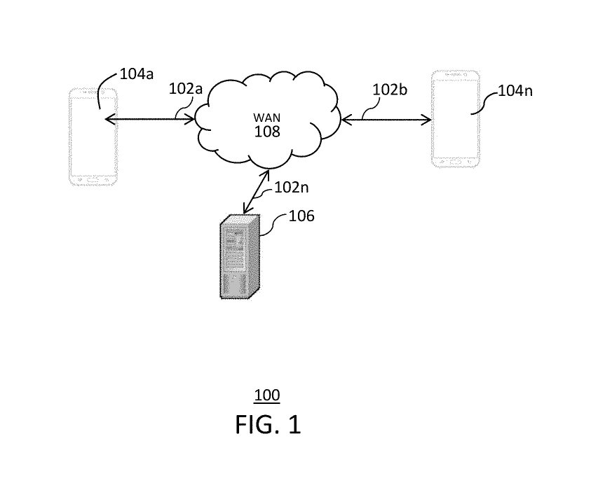

Referring now to FIG. 1, one embodiment of the present invention is shown as a block diagram, illustrating an exemplary network of data processing system in which the present invention may be implemented. FIG. 1 shows several advantageous features of the present invention, but, as will be described below, the invention can be provided in several shapes, sizes, combinations of features and components, and varying numbers and functions of the components. The first example of a closed network 100, as shown in FIG. 1, includes connections 102a-n, which are the medium used to provide communication links between various devices and computers connected together within the network 100. The connections 102a-n may be wired or wireless connections, but said connections are preferably wireless. A few exemplary wired connections are cable, phone line, and fiber optic. Exemplary wireless connections include radio frequency (RF) and infrared radiation (IR) transmission. Many other wired and wireless connections are known in the art and can be used with the present invention.

In the depicted example, the network 100 includes a plurality of users 104a-n communicatively coupled together and/or to one or more server(s) 106 over the network 100. The computing devices 104a-n, which may be a cellphone or tablet, for example, are operable to execute programming instructions embodied in a software application that can be received from the administrative server 106 via a wide area network (WAN) 108. In other embodiments, the computing devices 104a-n are operable to execute the programming instructions received from the server 106 over the WAN 108. In yet other embodiments, the software application is a web-based software application, a desktop software application, or a mobile device software app. In one embodiment, the WAN is the Internet. The Internet represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 100 also may be implemented as a number of different types of networks, such as for example, an Intranet, a local area network (LAN), or a cellular network. FIG. 1 is intended as an example, and not as an architectural limitation for the present invention.

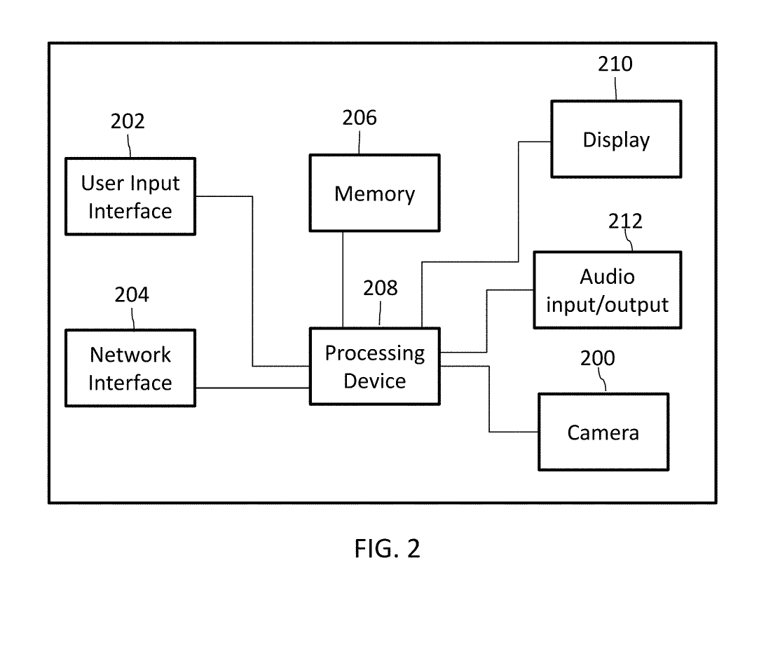

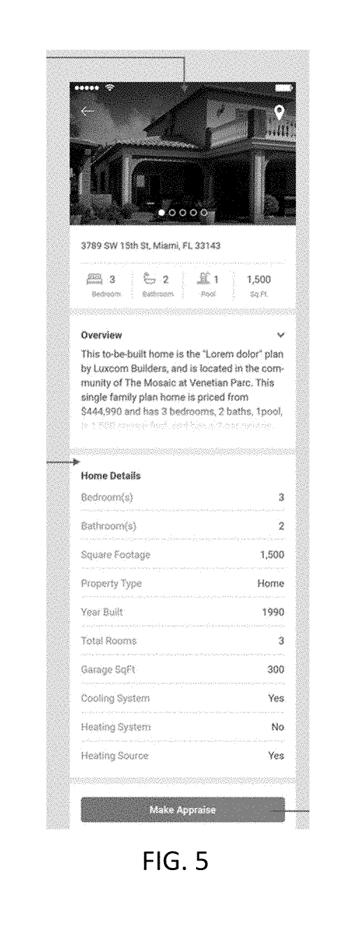

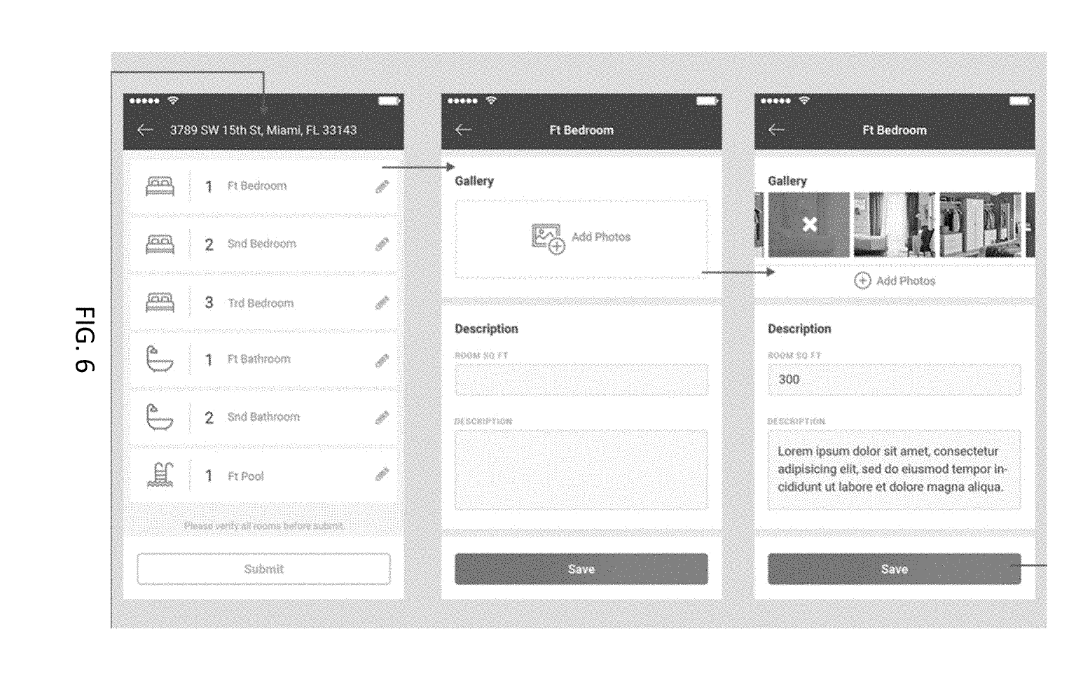

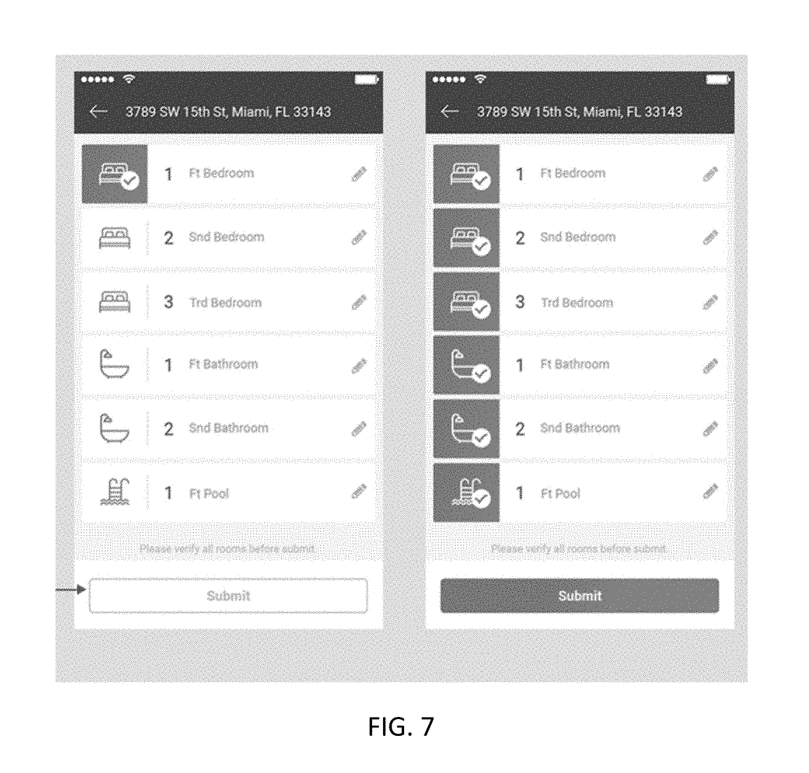

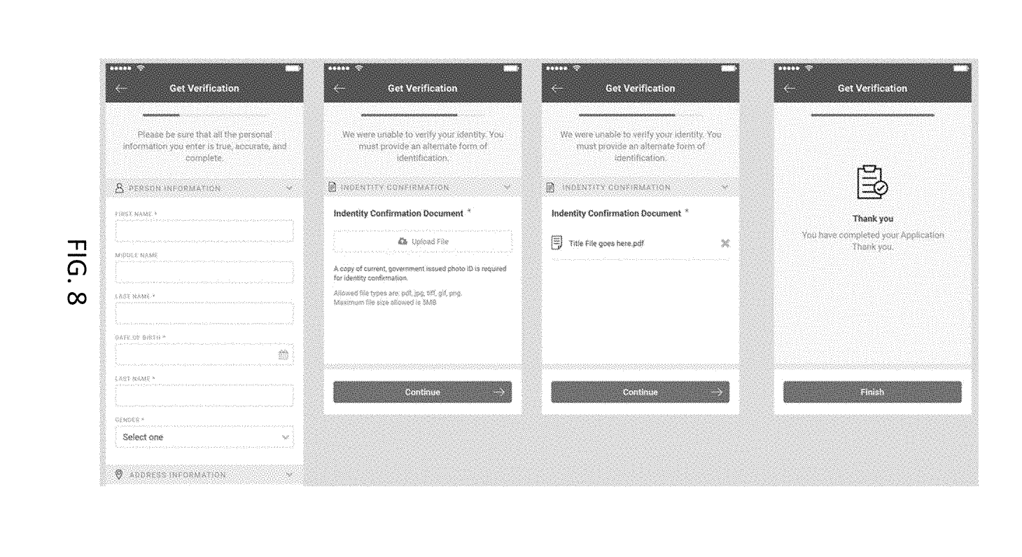

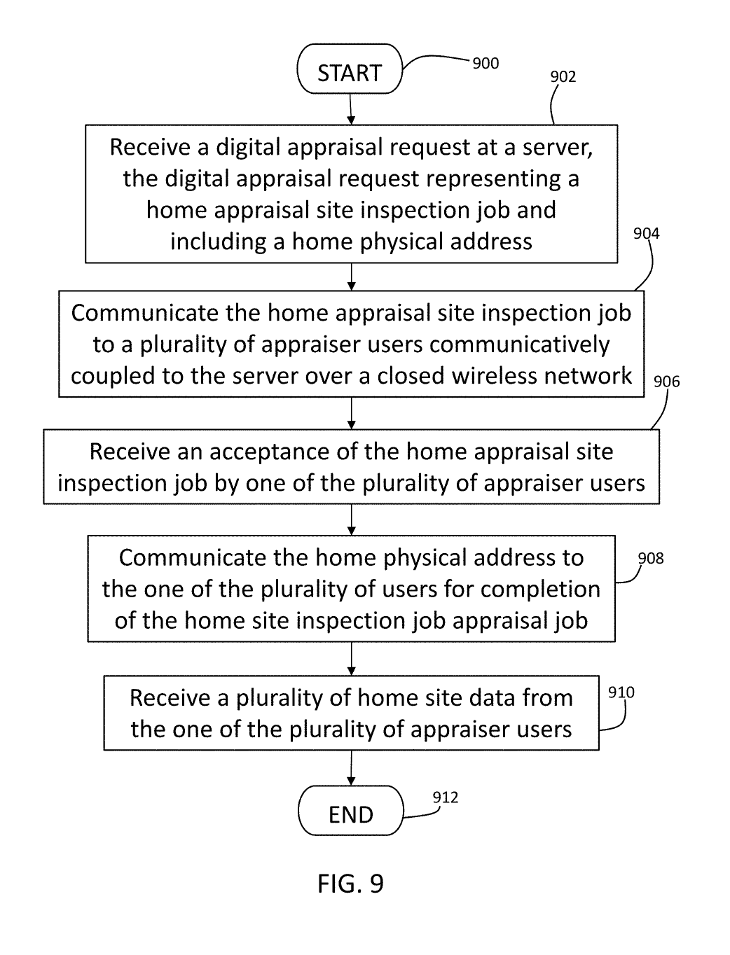

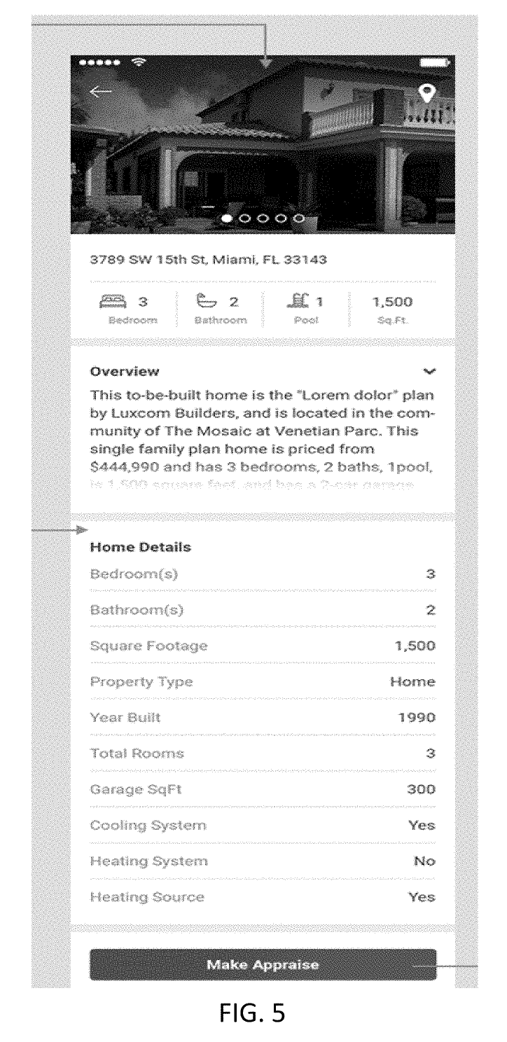

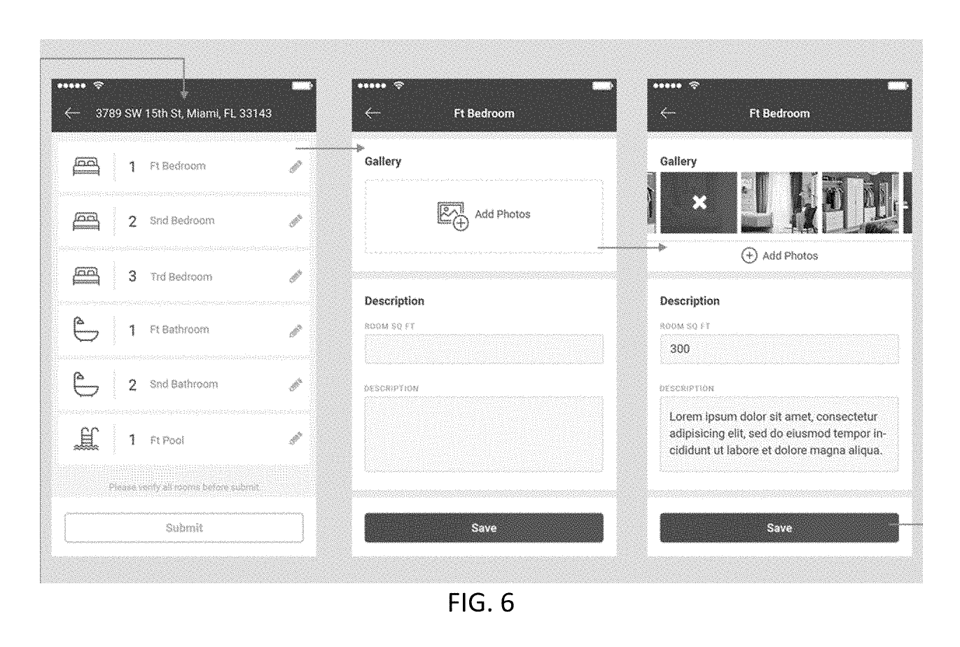

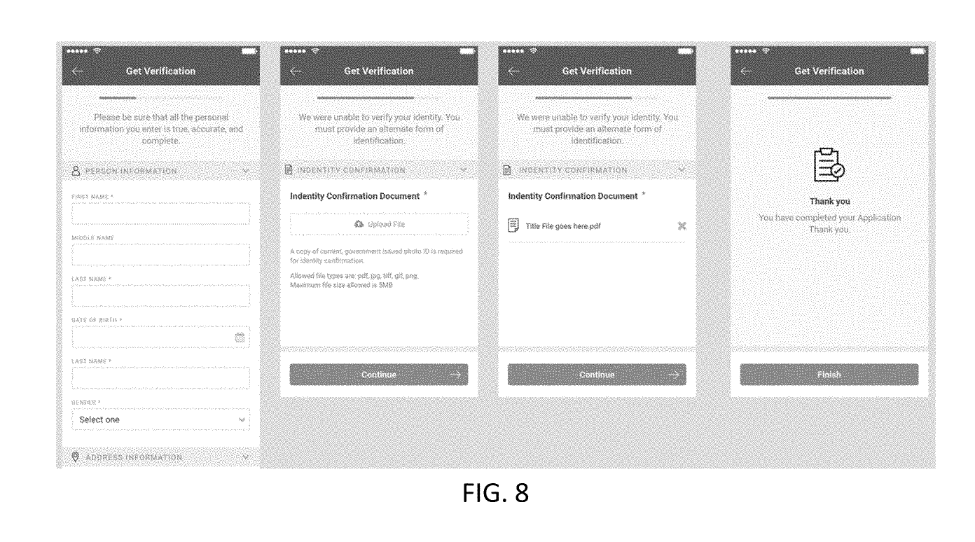

Using FIG. 1 in connection with FIGS. 2-9, an appraisal method exemplified through screen shots of the program used to implement the method are depicted. Moreover, FIGS. 1-8 also will be described in conjunction with the process flow chart of FIG. 9. Although FIG. 9 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 9 for the sake of brevity. In some embodiments, some or all of the process steps included in FIG. 9 can be combined into a single process.

The process may begin at step 900 and immediately proceed to the step 902 of receiving a digital appraisal request at the server, e.g., server 106, the digital appraisal request representing a home appraisal site inspection job and including a home physical address. The digital appraisal request may be sent by a banking institution user or other lending user.

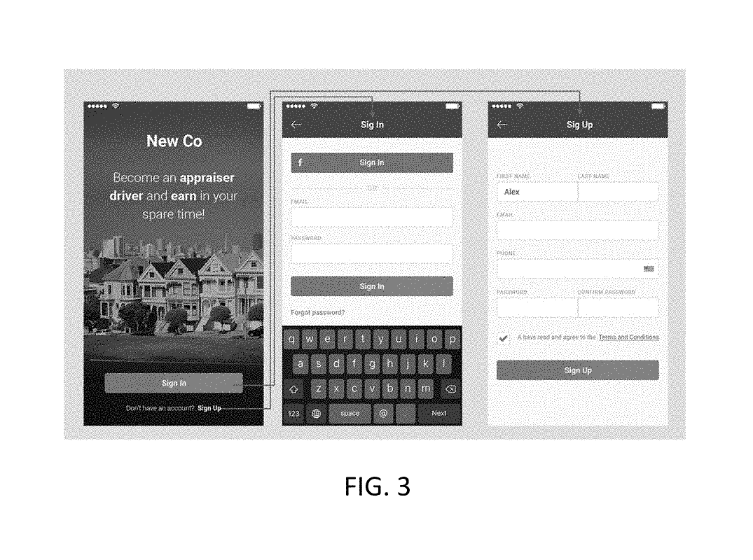

Generally, for an appraisal of a home or other building, 99% of the information about the home can be found online. However, in many instances, getting the physical site inspection of the home, which is required by most, if not all appraisals, is a difficult process due to the lack of availability and/or time for those who inspect said homes, which are generally only licensed appraisers. Before or after receiving the digital appraisal request, a plurality of appraisal users 104a-n will download a software application, thereby enabling the plurality of appraiser users 104a-n to receiving communications from the server 106 or other device on the network. The network is “closed” in that users are required to obtain permission, from an administrator or lender, to access certain information relating to the home appraisal site inspection job, or user are able to get push notifications from a system administrator relating to a home appraisal site inspection job. A user may login with a username/password or create a user account (seen in FIG. 3). In preferred embodiments, the appraisal user will go through a verification process, where a user's identity is confirmed, and/or a background check is performed before a user can be logged in and/or have access to a home needing an appraisal.

The server 106, which is preferably controlled by an administrator, receives and/or stores each user's information on a memory housed on the server for recall and use when needed. The server also receives, from a home owner, real estate agent/attorney, banks, credit lenders, interested parties, insurer, etc., a digital appraisal request, wherein the digital appraisal request represents a home appraisal job that includes the home physical address needing the appraisal. In other embodiments, the appraisal request may be provided through other means, e.g., written, verbally, etc. After receipt of the digital appraisal request, the server 106, through one or more processor(s), e.g., processor(s) 208, will carry out a step 904 of communicating the home appraisal site inspection job to a plurality of appraiser users 104a-n communicatively coupled to the server over the closed wireless network. Said another way, the home appraisal site inspection job will only be communicated to those appraiser users 104a-n preapproved, vetted, and/or authorized to receive certain information relating to a home appraisal site inspection job. The system may be operably configured to routinely provide testing to and/or compliance safeguards with appraiser users 104a-n in order to ensure he or she is authorized to receive notification of the home appraisal site inspection job.

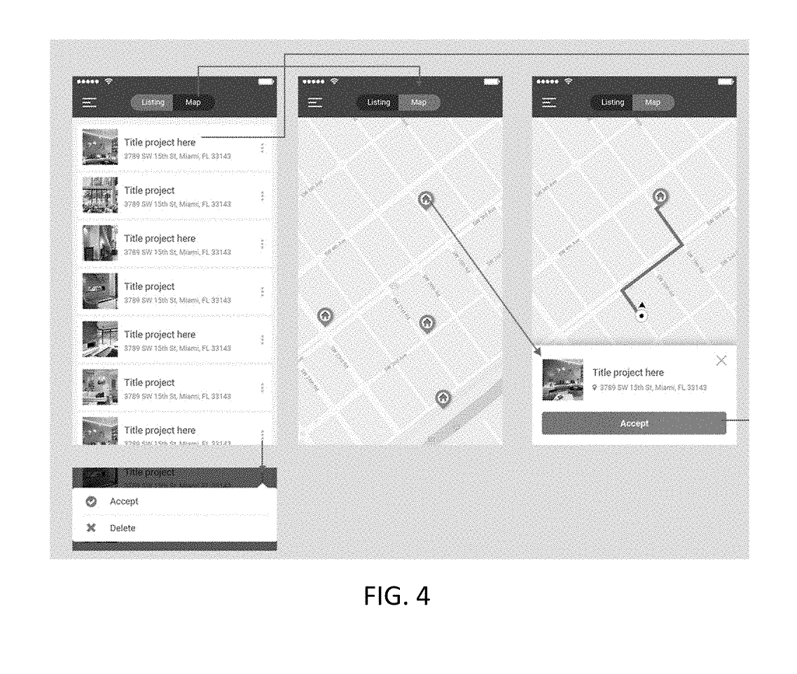

In one embodiment, the home appraisal site inspection job includes information regarding the approximate location (e.g., city or geographic region/area) is relayed to the users, along with a description of the attributes of the home, e.g., bedroom(s), bathroom(s), etc., and desired time and payment amount for the physical site inspection for the appraisal. In one embodiment the payment amount is controlled through an automatic scaling protocol based principally on supply of appraiser user 104a-n in a given area and demand for site appraisals. The location of the home(s) are preferably graphically depicted, generally, through use of an icon disposed on a graphical user interface (“GUI”) of the appraiser user's computing device (e.g., as depicted in FIG. 4). The software application may also include a graphical and/or textual list of locations needing appraisal, wherein a user may accept one or more of said home appraisal job(s). In one embodiment, the software application only permits one distinct user to access, view, and/or accept one or more of said home appraisal job(s), determined, for example, by ascertaining the personal computing ID for each user, e.g., IP Address and/or MSIN.

Once a user accepts the home appraisal site inspection job, typically provided via a user input on a GUI on a computing user interface of an appraisal user, the process may continue to the step 906 of receiving, at the server 106, an acceptance of the home appraisal site inspection job by one of the plurality of appraiser users 104a-n. In some embodiment, the server initiates a timer after communicating the home appraisal site inspection job to the plurality of appraiser users. The timer would dictate which appraiser user 104a-n receives the home physical address of the home site inspection job appraisal job, i.e., communication of said information would correspond to a first received acceptance of the home appraisal site inspection job by an appraiser user based on the timer.

After acceptance of an appraiser job is received at the server 106, step 908 of the process may include communicating the home physical address to the one of the plurality of users for completion of the home site inspection job appraisal job. Specifically, the software application may provide the user step-by-step and/or graphical directions to the site where appraisal is to occur. Additionally, the user may be provided with one or more graphical interfaces depicting or representing the physical room(s) at the appraisal site needing verification and/or measuring. To effectuate the measurement aspect of the appraisal, the software application may include a room measurement tool that facilitates in estimating room dimensions through known digital image processing methods. In other embodiments, room dimensions are manually inserted by the user, whether through, for example, manual or mechanical measurements. Only after the user verifies and measures each room on an appraisal site, the software application will permit the user to submit the information to the server for further processing. Said another way, step 910 may include receiving, at the server 106, a plurality of home site data (as described above) from the one of the plurality of appraiser users 104a-n. Once the job is confirmed as completed, the software application may initiate a funds transfer to the user's desired account and/or the administrator will initiate payment to the user.

The process may include communicatively and dynamically integrating an MLS electronic database with the server 106. Said another way, the MLS, or multiple listing system or multiple listings service, is a suite of services that real estate brokers use to establish contractual offers of compensation (among brokers) and accumulate and disseminate information to enable appraisals. An MLS electronic database and software is used by real estate brokers in real, representing sellers under a listing contract to widely share information about properties with other brokers who may represent potential buyers or wish to work with a seller's broker in finding a buyer for the property or asset. Before, during, or after communicating the home physical address to the one of the plurality of users 104a-n for completion of the home site inspection job appraisal job, the system or server 106 is operably configured to autonomously receive a plurality of home appraisal site inspection job data from the MLS electronic database. The plurality of home appraisal site inspection job data from the MLS electronic database may assist in providing the appraiser user accepting the job listing to confirm information associated with the property, insert missing information within fields provided for on the user interface of the computing device of the appraiser user, and/or for computing, after receiving the plurality of home site data from the one of the plurality of appraiser users and from the plurality of home appraisal site inspection job data from the MLS electronic database, the appraisal value from the home site data and the home appraisal site inspection job data. The plurality of home appraisal site inspection job data from the MLS electronic database may be dynamically crawled or scraped for real-time or near-real time updates on a particular property associated with the home appraisal site inspection job. The process may terminate at step 912.

To accomplish the aforementioned processes, the server may be a computer that manages access to a centralized resource or database, e.g., text, audio and/or visual content for communication to a user's mobile device and/or a display associated with the user's computing device. Users can request and/or download the software application embodying an exemplary method of the present invention on their cellular phone. The server 106 can receive, process, and satisfy the request by sending the software application to the personal mobile computing devices via the WAN 108.

With reference now to FIG. 2, the personal computing devices are illustrated in a block diagram. The personal computing devices may include a camera 200, a user input interface 202, a network interface 204, a memory 206, a processing device 208, a computer display 210, and an audio input/output 212. The camera 200 may include a camera lens 201 and may be operable to capture still images, as well as, video. The camera 200 is preferably a digital camera so that the images may be stored in the memory 206 and processed by the processing device 208 on a user's cellular phone and/or remotely at the administrator server 106. The camera 200 may be communicatively coupled to a microphone for capturing audio, as well as, simultaneous visual video images.

The user input interface 202 functions to provide the user a method of providing input to the personal computing devices. The user input interface 202 may also facilitate interaction between the user's computing devices and/or the server 106. The user input interface may be a keypad providing a variety of user input operations. For example, the keypad may include alphanumeric keys for allowing entry of alphanumeric information (e.g. telephone numbers, contact information, content for display, text, etc.). The user input interface 202 may include special function keys (e.g. a camera shutter button, volume control buttons, back buttons, home button, etc.), navigation and select keys, a pointing device, and the like. Keys, buttons, and/or keypads may be implemented as a touchscreen associated with the computer display 210. The touchscreen may also provide output or feedback to the user, such as haptic feedback or orientation adjustments of the keypad according to sensor signals received by motion detectors, such as an accelerometer, located within the devices.

The network interfaces 204 may include one or more network interface cards (NIC) or a network controller. In some embodiments, the network interface 204 may include a personal area network (PAN) interface. The PAN interface may provide the capability for the user's computing devices to network using a short-range communication protocol, for example, a Bluetooth communication protocol. The PAN interface may permit one personal computing devices to connect wirelessly to another personal computing device via a peer-to-peer connection.

The network interfaces 204 may also include a local area network (LAN) interface. The LAN interface may be, for example, an interface to a wireless LAN, such as a Wi-Fi network. The range of the LAN interface may generally exceed the range available via the PAN interface.

Typically, a connection between two electronic devices via the LAN interface may involve communication through a network router or other intermediary device.

Additionally, the network interfaces 204 may include the capability to connect to a wide area network (WAN) via a WAN interface. The WAN interface may permit a connection to, for example, a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

The personal computing devices of the users 104a-n may also include a near field communication (NFC) interface. The NFC interface may allow for extremely close-range communication at relatively low data rates (e.g., 424 kb/s). The NFC interface may take place via magnetic field induction, allowing the NFC interface to communicate with other NFC interfaces located on other mobile computing devices or to retrieve information from tags having radio frequency identification (RFID) circuitry. The NFC interface may enable initiation and/or facilitation of data transfer from and to the personal computing devices with an extremely close range (e.g. 4 centimeters).

A memory 206 associated with the user's computing devices may be, for example, one or more buffer, a flash memory, or non-volatile memory, such as random-access memory (RAM). The personal computing devices may also include non-volatile storage. The non-volatile storage may represent any suitable storage medium, such as a hard disk drive or non-volatile memory, such as flash memory. The processing device 208 can be, for example, a central processing unit (CPU), a microcontroller, or a microprocessing device, including a “general purpose” microprocessing device or a special purpose microprocessing device. The processing device 208 executes code stored in memory 206 to carry out operation/instructions of the personal mobile computing devices. The processing device 208 may provide the processing capability to execute an operating system, run various applications, and provide processing for one or more of the techniques described herein.

The computer display(s) may depict information regarding the appraisal site, the user, and/or other pertinent information for the user(s), along with other content, e.g., telephone numbers, routing/bank transfer information, various menus, application icons, pull-down menus, and the like. The computer display 210 may be used to present various images, text, graphics, or videos to the user, such as photographs, mobile television content, Internet webpages, and mobile application interfaces. The computer display 210 may be any type of suitable display, such as a liquid-crystal display (LCD), a plasma display, a light-emitting diode (LED) display, or the like.

The personal computing devices may also include audio input and output structures 212, such as a microphone for receiving audio signals from a user and/or a speaker for outputting audio signals, and the like. As such, in one embodiment, the software application will confirm the identify the user through matching the unique voice characteristics obtained from the user during the verification process at the outset of registration to the user's voice required to used be to verify the existence of one or more rooms at the appraisal site. The personal computing devices may also include an audio port for connection to peripheral audio input and output structures, such as a headset, or peripheral speakers or microphones.

Once the user completes the home appraisal site inspection job as discussed above, the appraisal request may also be completed by generating a completed site appraisal form, that may be physically printed and/or produced digitally for transmission to the requestee. In some embodiments, the server will autonomously or manually collect and/or collate information regarding the appraised home, site, and/or location. This information may be retrieved from and/or scraped from data sources such as the MLS, world wide web, and the like.

What is claimed is:

1. A software-implemented appraisal method including the following steps of comprising:
receiving a digital appraisal request at a server, the digital appraisal request representing a home appraisal site inspection job and including a home physical address;
communicating, from the server, the home appraisal site inspection job to a plurality of appraiser users communicatively coupled to the server over a closed wireless network;
receiving, at the server, an acceptance of the home appraisal site inspection job by one of the plurality of appraiser users;
after acceptance of the home appraisal site inspection job by one of the plurality of appraiser users, communicating the home physical address to the one of the plurality of users for completion of the home site inspection job appraisal job; and
receiving, at the server, a plurality of home site data from the one of the plurality of appraiser users.

2. The software-implemented appraisal method according to claim 1, further comprising:
computing, after receiving the plurality of home site data, an appraisal value utilizing the plurality of home site data.

3. The software-implemented appraisal method according to claim 2, further comprising:
initiating, after communicating the home appraisal site inspection job to the plurality of appraiser users, a timer on the server, wherein the home physical address of the home site inspection job appraisal job is communicated to the one of the plurality of appraiser users corresponding to a first received acceptance of the home appraisal site inspection job based on the timer.

4. The software-implemented appraisal method according to claim 2, further comprising:
communicatively and dynamically integrating an MLS electronic database with the server;
autonomously receiving a plurality of home appraisal site inspection job data from the MLS electronic database; and
computing, after receiving the plurality of home site data from the one of the plurality of appraiser users and from the plurality of home appraisal site inspection job data from the MLS electronic database, the appraisal value from the home site data and the home appraisal site inspection job data.

5. The software-implemented appraisal method according to claim 1, further comprising:
communicating the home physical address to the one of the plurality of users for completion of the home site inspection job appraisal job by a banking institution.

6. The software-implemented appraisal method according to claim 1, further comprising:
receiving, at the server, an acceptance of the home appraisal site inspection job through a user input provided on an electronic computing device of the one of the plurality of appraiser users, the electronic computer device communicatively coupled to the closed wireless network.
